(19) United States
(12) Patent Application Publication
(10) Pub. No.: US 2023/0286876 A1
(43) Pub. Date: Sep. 14, 2023

(54) CARBON HYDROGEN CORE FERTILIZER AND METHOD FOR PREPARING THE SAME

(71) Applicant: Guanglin GAO, Zouping (CN)

(72) Inventor: Guanglin GAO, Zouping (CN)

(21) Appl. No.: 17/886,288

(22) Filed: Aug. 11, 2022

(30) Foreign Application Priority Data
Mar. 10, 2022 (CN) 2022102405295

(51) Int. Cl. C05F 11/00; C05F 5/00

(52) U.S. Cl. CPC C05F 11/00; C05F 5/002

(57) ABSTRACT

A carbon hydrogen core fertilizer is provided, consisting components as follows: 14 wt % to 16 wt % of polyglutamic acid, 16 wt % to 18 wt % of amino acid, 13 wt % to 14 wt % of oligose, 23 wt % to 25 wt % of seaweed, 2 wt % to 4 wt % of organosilicon, 10 wt % to 12 wt % of chitosan oligosaccharide, and the balance of water. With the carbon hydrogen core fertilizer, carbon dioxide in the air can be adsorbed and enriched around stems and leaves of plants for the plants to absorb, thereby strengthening photosynthesis, increasing a photosynthetic rate, inhibiting photorespiration, accelerating the yield of chlorophyll, improving and strengthening the growth of crops and the accumulation of dry matter, and realizing the increase of the yield and income of the crops.

### TECHNICAL FIELD

The present disclosure relates to the field of agriculture, and in particularly to a carbon hydrogen core fertilizer and a method for preparing a carbon hydrogen core fertilizer.

### DESCRIPTION OF RELATED ART

Traditionally, an application principle of chemical fertilizers is “promoting leaves by roots”. At present, most commonly used fertilizers are required to be buried in soil, and nutrients for crops can only be absorbed by the roots and then transmitted to leaves and stems. Since the chemical fertilizers and pesticides are used for decades, hardening and poisoning of the soil tend to be serious, productivity and activity of the soil are getting worse and worse, and transmission mechanism of the nutrients for the crops is weakening. As such, most of the nutrients for crops are absorbed by fruits close to the roots first, fruits farther away from the roots thus get less nutrients, and high yield is difficult to be achieved.

Photosynthesis of plants is a process of using energy of sunlight to synthesize carbon dioxide and water into an organic matter, i.e., a carbohydrate and release oxygen. The photosynthesis must be carried out in chloroplasts of the plants, because only pigment of the chloroplasts, i.e., chlorophyll, can absorb light energy and convert the light energy into chemical energy. Light is required for the photosynthesis, is an energy source of the photosynthesis, and is essential for forming the chlorophyll. Three elements needed for the photosynthesis are carbon, hydrogen and oxygen, namely carbon dioxide (CO₂), hydrogen (H) and water (H₂O), which are raw materials for synthesis of the carbohydrate (CH₂O+O₂). In short, an agricultural yield is a process of using the photosynthesis of crops to produce the organic matter. The photosynthesis (a process of absorbing CO₂ to produce O₂) makes and increases the nutrients, and photorespiration (a process of absorbing O₂ and exhaling CO₂) consumes the nutrients, therefore, it is a feasible idea to increase yield and income by promoting the photosynthesis and inhibiting the photorespiration.

In the 21st century, with increase of carbon emissions, the content of carbon dioxide (CO₂) per cubic meter of air on the earth's surface has also increased significantly. How to make use of these abundant “natural resources” to improve an intensity of the photosynthesis of the plants and realize the increase of the yield and income of the plants on the basis of environmental protection and no pollution of the soil is a problem worth studying.

### SUMMARY

Therefore, the present disclosure provides a carbon hydrogen core fertilizer and a method for preparing a carbon hydrogen core fertilizer, for solving the problems existing in the above related art.

To solve the above problems, the present disclosure provides following technical solutions.

In a first aspect, a carbon hydrogen core fertilizer is provided, which may consist of components as follows: 14 wt % to 16 wt % of polyglutamic acid, 16 wt % to 18 wt % of amino acid, 13 wt % to 14 wt % of oligose, 23 wt % to 25 wt % of seaweed, 2 wt % to 4 wt % of organosilicon, 10 wt % to 12 wt % of chitosan oligosaccharide, and the balance of water.

In an optional embodiment, the oligose is brown algae oligosaccharide.

In a second aspect, a method for preparing the carbon hydrogen core fertilizer is provided, which may include steps:

S1, weighing raw materials consisting of: 14 wt % to 16 wt % of polyglutamic acid, 16 wt % to 18 wt % of amino acid, 13 wt % to 14 wt % of oligose, 23 wt % to 25 wt % of seaweed, 2 wt % to 4 wt % of organosilicon, 10 wt % to 12 wt % of chitosan oligosaccharide, and the balance of water;

S2, heating the water weighed in the step S1 to be with a temperature in a range of 50° C. to 60° C., and adding the polyglutamic acid, the oligose and the chitosan oligosaccharide into the heated water and stirring uniformly to obtain a mixture A;

S3, adding the seaweed and the amino acid into the mixture A when a temperature of the mixture A is cooled down to be in a range of 30° C. to 35° C., and stirring uniformly to obtain a mixture B; and

S4, adding the organosilicon into the mixture B when a temperature of the mixture B is cooled down to room temperature, and stirring uniformly to obtain the carbon hydrogen core fertilizer.

Compared with the related art, the present disclosure has at least the following beneficial effects.

(1) The carbon hydrogen core fertilizer disclosed by the present disclosure is a new type of clean fertilizer, in which a scientific principle of “increasing carbon dioxide concentration around crops can increase the crop yield” is applied, amino acid, oligose, seaweed, chitosan oligosaccharide and the like are adopted as carbon dioxide adsorbents, and a physical method is used after scientific formulation. With the carbon hydrogen core fertilizer, carbon dioxide in the air can be adsorbed and enriched around stems and leaves of plants for the plants to absorb, thus strengthening photosynthesis, increasing photosynthetic rate, inhibiting photorespiration, accelerating the yield of chlorophyll, and improving and strengthening the growth of crops and the accumulation of dry matter. After the carbon hydrogen core fertilizer disclosed by the present disclosure is applied to the leaves and stems of the plants. On the one hand, on the premise of no or less use of chemical fertilizers and chemical pesticides, the carbon dioxide in the atmosphere can be efficiently captured, and the concentration of the carbon dioxide around the leaves and stems of the plants can be obviously increased, so that the photosynthetic rate can be increased and the photorespiration can be inhibited to promote crop yield; while on the other hand, the carbon hydrogen core fertilizer can provide efficient nutrition for crops by itself, which is combined with the enhancement of the ability of the plants to absorb the carbon dioxide, thereby further realizing the increase of the yield and income of the crops.

(2) The carbon hydrogen core fertilizer disclosed according to the present disclosure can increase a content of the carbon dioxide around an application place from about 400 parts per million (ppm) to about 1200 ppm, obviously promote the photosynthesis of plants, and increase the nutrient (C/H/O) supply of the plants by more than 2 times.

(3) The carbon hydrogen core fertilizer disclosed according to the present disclosure can be applied to the stems, leaves, flowers, buds, fruits, roots and other organs of plants (as long as they see light, such as hydroponics), which can improve the supply of nutrients (C/H/O) around them, enhance simultaneously their own photosynthesis intensity, and provide balanced support.

(4) The carbon hydrogen core fertilizer disclosed according to the present disclosure can inhibit the photorespiration of plants, which can further increase the yield and income of the crops.

(5) The carbon hydrogen core fertilizer disclosed according to the present disclosure directly fixes nitrogen in the atmosphere by the seaweed, and directly provides a high-concentration nitrogen source for leaf surface through converting.

(6) The amino acid contained in the carbon hydrogen core fertilizer disclosed according the present disclosure is a basic substance of protein. The protein is the basic substance of life-sustaining activities. All life is the basic form of protein. The amino acid in the carbon hydrogen core fertilizer of the present disclosure are absorbed by the surface of the leaves and stems of the crops under the photosynthesis, and directly enter the crops to synthesize the protein and nucleic acid, thus forming various organs of the crops, for maintaining and strengthening the vitality of the crops. The main function of the amino acid is to directly provide nutrition for the crops.

(7) Due to its specific formula, the carbon hydrogen core fertilizer disclosed according to the present disclosure has a better miscibility with pesticides, and is not easy to produce flocculation after mixing. The molecular weight thereof is evenly distributed, immune induction and resistance activity is high, and prevention and treatment of plant diseases can be done concurrently.

(8) The seaweed contained in the carbon hydrogen core fertilizer disclosed according to the present disclosure can directly fix nitrogen in the atmosphere. In addition, the seaweed has special solidification and environmental protection functions. According to the present disclosure, the seaweed is contained such that: firstly, protein and rich trace elements contained in the seaweed up to 70% are fully utilized as nutrients for the crops to absorb and transform; more importantly, it can give full play to the solidification and environmental protection functions of the seaweed. The solidification and environmental protection functions of seaweed include: it can fix nitrogen in the atmosphere, provide nitrogen fertilizer for the crops through foliage, and reduce nitrogen particles in the air (nitrogen particles are commonly known as particulate matter (PM) 2.5), effectively reducing air smog; the seaweed can fix and remove harmful heavy metal residues (arsenic, lead, cadmium, etc.), chemical fertilizer and pesticide residues and refractory organic substances in the soil by acting on the crops, so that they can no longer pollute agricultural products, thus ensuring the organic quality of the agricultural products. In addition, the seaweed has powerful functions such as light photosynthesis, carbon fixation and oxygen release, self-support, pronuclear decomposition, targeted transportation, hydrogen generation and nitrogen accumulation, and strong stress resistance. It also has a powerful mechanism of providing more than 98% of four nutrient elements of carbon, hydrogen, oxygen and nitrogen to green plants, and effectively absorbing more than 80 types of organic nutrients such as phosphorus, potassium, calcium, magnesium, sulfur, iron, manganese, zinc, boron, molybdenum, copper and chlorine in soil.

(9) After acting on the crops with the carbon hydrogen core fertilizer disclosed according to the present disclosure, the crops can quickly generate roots within 8 days, the number of the roots of the crops is double within 15 to 20 days, and has obvious effect of improving the growth of the crops.

(10) The carbon hydrogen core fertilizer disclosed according to the present disclosure can effectively solve the ecological and environmental problems and food safety problems caused by chemical fertilizers in planting and crop growth, and bring remarkable economic benefits, ecological benefits and health wealth to human society.

(11) The carbon hydrogen core fertilizer disclosed according to the present disclosure enriches carbon dioxide around the leaves and stems of the crops, enhances the photosynthesis, increases photosynthetic rate, inhibits respiration at night, improves the absorption efficiency of the nutrients of the soil by the roots of the crops, realizes promoting roots by leaves, increases crop growth and accumulation, reduces the amount of chemical fertilizer, and improves the yield and quality of the crops.

(12) The carbon hydrogen core fertilizer disclosed according to the present disclosure can obviously increase the carbon dioxide concentration around the leaves and stems of the crops, and the environment with high carbon dioxide concentration is not conducive to the survival and reproduction of pests, thereby indirectly achieving effect of repelling and killing pests, reducing the amount of pesticides used, and protecting beneficial organisms such as frogs, bees, birds and wildlife.

(13) The method for preparing the carbon hydrogen core fertilizer disclosed according the present disclosure has zero emission in the process, and the produced carbon hydrogen core fertilizer can make the crops absorb more carbon dioxide to increase yield after being used, and thus turning waste into wealth.

(14) The carbon hydrogen core fertilizer disclosed according to the present disclosure can significantly reduce the application amount of chemical fertilizer. After the application amount of chemical fertilizer is reduced, soil hardening is gradually improved, an aggregate structure is restored, water storage and gas storage capacity is enhanced, and the soil permeability is improved, thereby improving the resistance of crops and reducing a use amount of pesticides, and the toxic and harmful substances such as nitrite, heavy metals, lead, arsenic and cadmium in the produced agricultural products are reduced, which is both beneficial to the health of consumers and can protect the environment.

(15) After being applied to the crops, the carbon hydrogen core fertilizer disclosed according to the present disclosure can significantly advance comprehensive flowering period of the crops by 7 to 21 days, and can improve a sugar degree of the crop fruits by 1 to 2 degrees, and increase the yield by 7% to 30%, and thus has a remarkable effect.

(16) The carbon hydrogen core fertilizer disclosed according to the present disclosure fully exerts the outstanding advantages of the principle of increasing yield of carbon dioxide, the principle of raising and feeding the whole crops, and the principle of nutrient trapping by promoting roots with leaves, so that the crops are in a strong state during the whole growth period from seed to harvest.

(17) The carbon hydrogen core fertilizer disclosed according to the present disclosure can improve the utilization rate of the fertilizer. According to the measurement, it can improve utilization rates of nitrogen by 60%, phosphorus by 5%, potassium by 18% and trace elements by 20%.

(18) The carbon hydrogen core fertilizer disclosed according the present disclosure can fully replace the traditional chemical fertilizer, so after the application, the aggregate structure of the soil can be restored, the water storage and gas storage capacity of the soil can be enhanced, the permeability of the soil can be improved, and the water activity of the soil can be restored. In addition, the carbon hydrogen core fertilizer disclosed according to the present disclosure has a function of insect control and disease treatment, so that root rot, blight, virus disease, mildew disease, fungal disease, etc., which are originally referred to as crop cancers, can be prevented and controlled, and the whole life of the crops from seed to harvest can be realized.

(19) The carbon hydrogen core fertilizer disclosed according to the present disclosure has a good effect of blocking pests and diseases, and a working mechanism thereof is as follows: 1. increasing carbon dioxide blocks a breeding environment of pests and diseases, the carbon dioxide content around the leaves and stems of chemical agricultural crops is 360 ppm to 400 ppm, which is a favorable environment for breeding of pests and diseases; after spraying carbon hydrogen core fertilizer, the carbon dioxide content around the crops can reach 120 ppm, which can completely block and change the possibility of the breeding of pests and diseases. 2. The carbon hydrogen core fertilizer disclosed according to the present disclosure contains green algae, which has a function of blocking three major systems of respiration, elimination and secretion of the pests, thus preventing and reducing the occurrence of the pests. Seed dressing and root dipping with the carbon hydrogen core fertilizer disclosed by the present disclosure can prevent the occurrence of diseases and insect pests of seedlings. After spraying a suitable dose of the carbon hydrogen core fertilizer disclosed according to the present disclosure in a growing period, a large-scale epidemic situation of diseases and insect pests can be prevented.

(20) The traditional application principle of chemical fertilizer is “promoting leaves by roots”. No matter what kind of fertilizer needs to be buried in the soil, nutrients for the crops can only be absorbed by the roots and transmitted to the leaves and stems. Due to the application of the chemical fertilizers and pesticides for decades, the soil hardening and poisoning are serious, the soil fertility activity is getting worse and worse, and the nutrient transmission mechanism of the crops is weakening. The raised part of the crops is absorbed by the fruits close to the roots first, so the fruits farther away from the roots get less nutrients, so it is difficult to form high yield. However, the application principle of the carbon hydrogen core fertilizer disclosed according to the present disclosure is “promoting roots with leaves”. The nuclear fertilizer sprayed on the roots, stems, leaves, flowers, buds, fruits and other plant organs of the crops can participate in photosynthesis. Each plant is like a self-sufficient small-scale breeding machine, which can provide balanced supplies nearby. The amount of the nutrients is not limited by the number of buds and fruits. The number of buds determines how many fruits can be harvested.

(21) The carbon hydrogen core fertilizer disclosed according to the present disclosure can balance a pH value of the soil and improve a content of an organic matter and water retention capacity of the soil.

(22) The carbon hydrogen core fertilizer disclosed according to the present disclosure has a function of slowly releasing nutrients, and can prolong efficiency of the fertilizer to 120 days.

(23) The carbon hydrogen core fertilizer disclosed according to the present disclosure has effects of resisting premature aging and promoting precocity for the crops, and improves the yield and quality of the crops. According to the measurement, a yield of grain crops can be increased by 15% to 20%, and a yield of cash crops can be increased by more than 60%.

(24) The carbon hydrogen core fertilizer disclosed according to the present disclosure has fourteen stress-resistant properties: insect resistance, disease resistance, lodging resistance, drought resistance, low temperature resistance, salt resistance, alkali resistance, overgrowth resistance, annual rotation resistance and continuous cropping resistance.

(25) The carbon hydrogen core fertilizer disclosed according to the present disclosure has following functional characteristics: activating sialic acid (SA) immune system of the crops, to thereby resist invasion of bacteria and viruses, and reduce the use of pesticides; inducing plants to synthesize abscisicacid (ABA) (which can increase the content of abscisic acid by 5 times), to thereby enhance the stress resistance of plants, mature early, market early, and coloring and sweeten; inducing plants to synthesize indole-3-aceticacid (IAA) (which can increase the auxin content of crops by 8 times), to thereby take root and sprout quickly, and grow fast.

### DETAILED DESCRIPTION OF EMBODIMENTS

In order to make objectives, technical solutions and advantages of the present disclosure be clearer, the present disclosure will be further explained in detail hereinafter in combination with specific embodiments. It should be understood that the specific embodiments described herein are merely for explaining the present disclosure, but not for limiting the present disclosure.

In the description of the present disclosure, terms “including” and “having” and any variations thereof are intended to indicate non-exclusive inclusion. For example, a process, a method, a system, a product or a device that includes a series of steps or units is not necessarily limited to merely include those steps or units that have been explicitly listed, but may also include other steps or units that are not explicitly listed but inherent to the process, the method, the system, the product or device, or also include steps or units added based on further optimized solutions of the concept of the present disclosure.

### First Embodiment

The first embodiment provides a carbon hydrogen core fertilizer, which is a carbon dioxide trapping agent and consists of components as follows: 14 wt % of polyglutamic acid, 16 wt % of amino acid, 13 wt % of brown algae oligosaccharide, 23 wt % of seaweed, 2 wt % of organosilicon, 10 wt % of chitosan oligosaccharide, and the balance of water.

A method for preparing the carbon hydrogen core fertilizer according to the first embodiment may include following steps S1 to S4:

S1, weighing raw materials consisting of: 14 wt % of polyglutamic acid, 16 wt % of amino acid, 13 wt % of brown algae oligosaccharide, 23 wt % of seaweed, 2 wt % of organosilicon, 10 wt % of chitosan oligosaccharide, and the balance of water;

S2, heating the water weighed in the step S1 to be with a temperature of 50 degrees Celsius (° C.), and adding the polyglutamic acid, the brown algae oligosaccharide and the chitosan oligosaccharide into the heated water and stirring uniformly to obtain a mixture A;

S3, adding the seaweed and the amino acid into the mixture A when a temperature of the mixture A is cooled down to be with a temperature of 30° C., and stirring uniformly to obtain a mixture B; and

S4, adding the organosilicon into the mixture B when a temperature of the mixture B is cooled down to room temperature, and stirring uniformly to obtain the carbon hydrogen core fertilizer.

### Second Embodiment

The second embodiment provides a carbon hydrogen core fertilizer, which is a carbon dioxide trapping agent and consists of components as follows: 15 wt % of polyglutamic acid, 17 wt % of amino acid, 13.5 wt % of brown algae oligosaccharide, 24 wt % of seaweed, 3 wt % of organosilicon, 11 wt % of chitosan oligosaccharide, and the balance of water.

A method for preparing the carbon hydrogen core fertilizer according to the second embodiment may include following steps S1 to S4:

S1, weighing raw materials consisting of: 15 wt % of polyglutamic acid, 17 wt % of amino acid, 13.5 wt % of brown algae oligosaccharide, 24 wt % of seaweed, 3 wt % of organosilicon, 1 wt % of chitosan oligosaccharide, and the balance of water;

S2, heating the water weighed in the step S1 to be with a temperature of 55° C., and adding the polyglutamic acid, the brown algae oligosaccharide and the chitosan oligosaccharide into the heated water and stirring uniformly to obtain a mixture A;

S3, adding the seaweed and the amino acid into the mixture A when a temperature of the mixture A is cooled down to be with a temperature of 33° C., and stirring uniformly to obtain a mixture B; and

S4, adding the organosilicon into the mixture B when a temperature of the mixture B is cooled down to room temperature, and stirring uniformly to obtain the carbon hydrogen core fertilizer.

### Third Embodiment

The third embodiment provides a carbon hydrogen core fertilizer, which is a carbon dioxide trapping agent and consists of components as follows: 16 wt % of polyglutamic acid, 18 wt % of amino acid, 14 wt % of brown algae oligosaccharide, 25 wt % of seaweed, 4 wt % of organosilicon, 12 wt % of chitosan oligosaccharide, and the balance of water.

A method for preparing the carbon hydrogen core fertilizer according to the thrid embodiment may include following steps S1 to S4:

S1, weighing raw materials consisting of: 16 wt % of polyglutamic acid, 18 wt % of amino acid, 14 wt % of brown algae oligosaccharide, 25 wt % of seaweed, 4 wt % of organosilicon, 12 wt % of chitosan oligosaccharide, and the balance of water;

S2, heating the water weighed in the step S1 to be with a temperature of 60° C., and adding the polyglutamic acid, the brown algae oligosaccharide and the chitosan oligosaccharide into the heated water and stirring uniformly to obtain a mixture A;

S3, adding the seaweed and the amino acid into the mixture A when a temperature of the mixture A is cooled down to be a temperature of 35° C., and stirring uniformly to obtain a mixture B; and

S4, adding the organosilicon into the mixture B when a temperature of the mixture B is cooled down to room temperature, and stirring uniformly to obtain the carbon hydrogen core fertilizer.

A test is conducted on the carbon hydrogen core fertilizer obtained in the second embodiment to explain beneficial effects of the present disclosure.

In the test, an experimental group and a control group are set up. Specifically, for the experimental group, the carbon hydrogen core fertilizer prepared according to the second embodiment is used, and for the control group, the carbon hydrogen diatom photonuclear fertilizer prepared according to the method disclosed in a reference document of Chinese patent application of No. CN202010214131.5 with a patent publication No. CN111362747A corresponding thereto.

A test method for the experimental group is conducted as follows.

The fertilizer used in the experimental group is the carbon hydrogen core fertilizer provided according to the second embodiment, and used as a foliar fertilizer.

An experimental crop is a multicolored sweet-waxy corn of No. 6.

An area of a test land is 667 m².

A test site is chonggu base of shanghai academy of agricultural sciences.

The test started on Aug. 10, 2018.

A fertilizer application method of the experimental group is shown in table 1.

TABLE 1
Fertilizer application method of the experimental group

| | Seeding | | Flowering | Filling |
|---|---|---|---|---|
| Item | period | Four leaves and one shoot period | period | period |
| Carbon | not applied | Spraying 30 milliliters (ml) of | spraying | spraying |
| hydrogen | | the carbon hydrogen core | 70 ml of | 100 ml of |
| core fertilizer | | fertilizer with 15 kilograms (kg) | the carbon | the carbon |
| according to | | of water; after 10 days, spraying | hydrogen | hydrogen |
| the second | | 50 ml of the carbon hydrogen | core | core |
| embodiment | | core fertilizer with 15 kg of | fertilizer | fertilizer |
| | | water | with 15 kg | with 15 kg |
| | | | of water | of water |
| Blank control | Normal | Normal | Normal | Normal |
| (conventional | management | management | management | management |
| treatment) | | | | |

The carbon hydrogen core fertilizer according to the second embodiment is applied from 9:00 a.m. to 10:30 a.m. and from 3:30 p.m. to 5:00 p.m., and is not combined with any drug or hormone fertilizer.

The test method of the control group is basically the same as that of the experimental group, with the difference that the carbon hydrogen core fertilizer according to the second embodiment is replaced by the light carbon hydrogen diatom core fertilizer prepared according to the method disclosed in the reference document of Chinese patent application No. CN202010214131.5 with a patent publication No. CN111362747A corresponding thereto.

Test results of the experimental group and the control group are shown in the following tables 2, 3 and 4.

TABLE 2
Effects of fertilizers in the experimental group and control group on yield of the corn

| | Fresh ear | Equivalent | Fresh ear | Fresh grain | |
|---|---|---|---|---|---|
| | yield per plot | yield per mu | comparison ± | yield per | Seed |
| Treatment | (kg) | (kg) | % | mu (kg) | yield % |
| Carbon hydrogen | 56.27a | 1406.79a | 9.84 | 1020.096 | 72.5a |
| core fertilizer in the | | | | | |
| experimental group | | | | | |
| Light carbon | 52.55b | 1313.75b | 2.58 | 854.45b | 65.04b |
| hydrogen diatom | | | | | |
| core fertilizer in the | | | | | |
| control group | | | | | |
| Blank control | 51.22b | 1280.73b | / | 807.576 | 63.06b |
| (conventional | | | | | |
| treatment) | | | | | |

TABLE 3
Effects of fertilizers in the experimental group and control group on main
characters of the corn

| | Ear | | | | | | Hundred- |
|---|---|---|---|---|---|---|---|
| | weigh | Ear length | Ear | Axis | | | grain |
| | (grams | (centimeters | diameter | diameter | Row | Grain | weight |
| Treatment | (g)) | (cm)) | (cm) | (cm) | number | number | (g) |
| Carbon | 426.1a | 21.8a | 5.1a | 1.7a | 14a | 46a | 48a |
| hydrogen | | | | | | | |
| core fertilizer | | | | | | | |
| in the | | | | | | | |
| experimental | | | | | | | |
| group | | | | | | | |
| Light carbon | 403.3a | 19.8b | 5.1b | 1.7a | 14a | 38b | 44a |
| hydrogen | | | | | | | |
| diatom core | | | | | | | |
| fertilizer in | | | | | | | |
| the control | | | | | | | |
| group | | | | | | | |
| Blank control | 388.3b | 19.3b | 5a | 1.9a | 14a | 35b | 38b |
| (conventional | | | | | | | |
| treatment) | | | | | | | |

TABLE 4
Comparison of leaf area in mature period for Different Treatments

| | | | Leaf area | |
|---|---|---|---|---|
| | Length | Width | (square meters | Leaf area |
| Treatment | (cm) | (cm) | (cm²)) | increased by % |
| Carbon | 92.5a | 9.7a | 672.0a | 15.2 |
| hydrogen core | | | | |
| fertilizer in the | | | | |
| experimental | | | | |
| group | | | | |
| Carbon | 86.6b | 9.6b | 623.25b | 6.9 |
| hydrogen diatom | | | | |
| photonuclear | | | | |
| fertilizer in the | | | | |
| control group | | | | |
| Blank control | 82.7b | 9.4a | 583.1b | / |
| (conventional | | | | |
| treatment) | | | | |

As can be seen from the table 2, the yield of the corn of the experimental group and the control group is higher than that of the conventional treatment, but the effect of the experimental group is obviously more prominent than the other two, with an increase of yield of 9.84%. The seed rate of the experimental group reaches to 72.51%, which was significantly higher than that of the control group with a seed rate of 65.04% and the conventional treatment with a seed rate of 63.06%.

As can be seen from the table 3, the ear weight, the ear length, the grain number and the hundred-grain weight of the corn treated under the experimental group are significantly improved compared with the control group and the conventional treatment; and there is no significant difference in the ear diameter and the axis diameter therebetween.

Ear leaves in the mature period under the three treatments are measured, a leaf area coefficient is 0.75 and specific results are shown in the table 4. After the treatment of the experimental group, the length of the ear leaf of the corn is significantly increased, and the leaf area is increased by 15.2% compared with that of the conventional treatment. Although the leaf area of the control treatment is also increased to some extent, the effect is not obvious compared with the conventional treatment.

In summary, it can be seen from the experiment, growth and development of the waxy corn treated with the carbon hydrogen core fertilizer according to the second embodiment is significantly better than those of the control group and the conventional treatment, and the leaf area is increased by 15.2% compared with that of the conventional treatment, thus promoting the increase of the ear length, the grain number, the hundred-grain weight and ear yield. Compared with the conventional treatment, measured yield per mu is increased by 9.8%.

The same experiments are carried out for the first and second embodiments as that for the second embodiment, and results thereof are basically consistent with that of the second embodiment, and all of them could basically achieve the beneficial effects to be achieved by the present disclosure.

The technical features of the above embodiments can be arbitrarily combined, and all possible combinations of the technical features in the above embodiments are not described for the purpose of concise description. These embodiments that are not explicitly written should also be considered to be fall in the scope of this specification.

The present disclosure is described above in detail by general description and the specific embodiments. However, it should be pointed out that, it is apparent that several modifications and improvements can be made to the specific embodiments without departing from the concept of the present disclosure, and all of the modifications and improvements fall within the scope of protection of the present disclosure. Therefore, the scope of protection of the present disclosure should be subject to the appended claims.

What is claimed is:

1. A carbon hydrogen core fertilizer, consisting of components as follows:
14 wt % to 16 wt % of polyglutamic acid,
16 wt % to 18 wt % of amino acid,
13 wt % to 14 wt % of oligose,
23 wt % to 25 wt % of seaweed,
2 wt % to 4 wt % of organosilicon,
10 wt % to 12 wt % of chitosan oligosaccharide, and
the balance of water.

2. The carbon hydrogen core fertilizer according to claim 1, wherein the oligose is a brown algae oligosaccharide.

3. A method for preparing the carbon hydrogen core fertilizer according to claim 1, comprising steps:
S1, weighing raw materials consisting of: 14 wt % to 16 wt % of polyglutamic acid, 16 wt % to 18 wt % of amino acid, 13 wt % to 14 wt % of oligose, 23 wt % to 25 wt % of seaweed, 2 wt % to 4 wt % of organosilicon, 10 wt % to 12 wt % of chitosan oligosaccharide, and the balance of water;
S2, heating the water weighed in the step S1 to be with a temperature in a range of 50° C. to 60° C., and adding the polyglutamic acid, the oligose and the chitosan oligosaccharide into the heated water and stirring uniformly to obtain a mixture A;
S3, adding the seaweed and the amino acid into the mixture A when a temperature of the mixture A is cooled down to be in a range of 30° C. to 35° C., and stirring uniformly to obtain a mixture B; and
S4, adding the organosilicon into the mixture B when a temperature of the mixture B is cooled down to room temperature, and stirring uniformly to obtain the carbon hydrogen core fertilizer.
